(19) United States
(12) Patent Application Publication
(10) Pub. No.: US 2024/0316654 A1
(43) Pub. Date: Sep. 26, 2024

(54) DRILLING DEVICE, IN PARTICULAR SUCTION DRILLING DEVICE, FOR DRILLING A DRILL HOLE

(71) Applicant: Heller Tools GmbH, Dinklage (DE)

(72) Inventor: Rainer Lampe, Dinklage (DE)

(21) Appl. No.: 18/612,424

(22) Filed: Mar. 21, 2024

(30) Foreign Application Priority Data
Mar. 22, 2023 (DE) 10 2023 107 236.6
Apr. 19, 2023 (DE) 10 2023 109 922.1

(51) Int. Cl. B23B 31/103; B23B 31/107; B23B 51/12

(52) U.S. Cl. CPC B23B 31/103; B23B 31/1078; B23B 51/12; B23B 2251/68

(57) ABSTRACT

A drilling device, wherein the drilling device has a drill bit fitting and a drill bit, wherein the drill bit fitting has a connection region for connection of the drilling device to a power drill, and a receiving region for receiving the drill bit, wherein the drill bit has a shank, which is received by the receiving region, in the fitted state and is fixed releasably in the axial direction by an axial drill bit securing means, wherein the shank has a securing region, wherein the securing region secures the drill bit against rotation relative to the drill bit fitting in the fitted state, wherein the securing region has a securing contour along its length, wherein the securing contour has a plurality of curved shank arc segments and a plurality of shank connecting segments, which connect the shank arc segments to one another at a plurality of shank connection points.

### CLAIM OF PRIORITY

This application claims the benefit of German Patent application No. DE 10 2023 107 236.6 filed on Mar. 22, 2023 and German Patent application No. DE 10 2023 109 922.1 filed on Apr. 19, 2023, the disclosures of which are incorporated herein by reference in their entirety.

### FIELD OF THE TECHNOLOGY

Various embodiments relate to a drilling device for drilling a drill hole, to a drill bit, to a drill bit fitting, to a sleeve, to a method for producing a drill bit, to a method for producing a drill bit fitting, and to a method for producing a sleeve.

### BACKGROUND

Drilling devices for drilling drill holes are known in the prior art in numerous embodiments. Thus, for example, drilling devices are used for drilling wood, plastics, ceramics, concrete, reinforced concrete and stone, both in the commercial and the domestic sector. While a large proportion of drilling devices comprise a drill bit which can be clamped directly in the drill chuck of a power drill, the drilling device under discussion first of all has a drill bit fitting, in which, on the one hand, a drill bit of the drilling device can be received and which, on the other hand, enables the drilling device to be connected to a power drill, such as a hammer, impact and/or rotary power drill.

The known prior art (DE 30 04 077 A1) from which some embodiments proceed relates to a drilling device. Here, the drilling device is designed as a suction drilling device, in which the construction material to be drilled is extracted as drilling dust during the drilling process. The known drilling device has a drill bit fitting and a drill bit, wherein the drill bit can be received in a receiving region of the drill bit fitting. By means of a connection region of the drill bit fitting, the drilling device can be releasably connected to a power drill, which accordingly enables drilling to be carried out by means of the drilling device. To enable the drill bit to be arranged in the drill bit fitting, the drill bit has a shank, which can be inserted into the receiving region of the drill bit fitting. In the known drilling device, the drill bit is fixed releasably in the drill bit fitting in the axial direction by means of an axial drill bit securing means, in this case specifically by a spring ring. Since, by virtue of its design, the axial drill bit securing means provides only very slight, if any, securing of the drill bit with respect to rotation during the drilling process, the shank of the known drilling device additionally has a central securing region for securing against rotation. Along its length, the securing region has an outer securing contour, which has two curved shank arc segments, which are connected to one another via two straight shank connecting segments at a plurality of shank connection points.

By means of an appropriately designed receiving region, the drill bit is fundamentally prevented from rotating relative to the drill bit fitting since, for instance, there is positive engagement between the part of the securing region which has the outer securing contour and the receiving region. By means of this rotationally secure connection of the drill bit and drill bit fitting, the torque is correspondingly also transmitted from the drill bit fitting to the drill bit.

Although the known drilling device is therefore perfectly suitable for drilling holes in different construction materials, it has proven disadvantageous that the securing region of the drill bit and the receiving region of the drill bit fitting nevertheless wear out relatively quickly. Thus, for example, it may happen that the drill bit sticks in the construction material during a drilling process, as a result of which relatively high torques are transmitted from the drill bit fitting to the drill bit, and damage may occur to the drill bit in the securing region and to the drill bit fitting in the receiving region.

Although other drilling devices are also known in the prior art (e.g. from DE 10 2019 123 995 A1), these are often more complex from the point of view of production and also assembly since additional elements for securing against rotation or the like may be provided.

### SUMMARY

The problem underlying some embodiments is therefore that of configuring and developing the known drilling device in such a way that it is optimized in respect of the demands mentioned, such that, in particular, a drilling device with a long life that is relatively easy to produce is provided.

The above problem is solved by various elements disclosed herein.

One aspects is the fundamental consideration that the securing contour is of corner-less design and therefore, in particular, the securing region, which has the securing contour, is of edge-less design. In the prior art, in contrast, the shank arc segments and the shank connecting segments intersect at an angle with respect to one another at the shank connection points, as a result of which a corner of the securing contour and therefore, over the length, an edge of the securing region, which has the securing contour, is formed at each of the shank connection points. The edge-less configuration of the part of the securing region which has the securing contour leads to improved force and torque transfer from the drill bit fitting to the drill bit, as a result of which it is quite possible, in particular, to transmit even any relatively large torques without the occurrence of damage or excessive wear to the drill bit and/or the drill bit fitting. The corner-less securing contour and the edge-less part of the securing region which has the securing contour can furthermore likewise be produced relatively easily, e.g. by corresponding milling by means of a milling cutter. Further components, such as securing pins, which have to be produced and correspondingly fitted in addition, are not required in various embodiments. This results in a drilling device which has a long life overall and is relatively easy to produce.

More specifically, in some embodiments, it is proposed that the shank arc segments and the shank connecting segments merge tangentially into one another at the shank connection points.

Various embodiments relate to configurations which relate to the securing contour. By means of a securing region with a rotationally symmetrical securing contour, fitting, in particular insertion, of the drill bit in the drill bit fitting is simplified. This can take place at different angular positions. A substantially identical design of the shank arc segments and/or shank connecting segments can simplify the design and production of the securing contour.

In various embodiments, the shank arc segments and the shank connecting segments are further developed in an advantageous way. In particular, uncurved shank connecting segments, i.e. segments of straight design, and curved shank arc segments, e.g. designed as part of an ellipse or of a circle, can provide a securing contour here which allows good torque transmission during drilling and, at the same time, is relatively simple to produce.

According to various embodiments, it is envisaged that the securing region extends not over the entire length but only over a part of the length of the shank. As a result, the shank can have one or more further shank regions, each with a shank contour, and, given appropriate configuration, this can improve the handling of the drilling device since, for example, certain functions, e.g. preventing the drill bit from slipping out of the drill bit fitting, can be implemented by the corresponding shank regions. The shank regions can be arranged one behind the other in the axial direction of the drill bit. Arrangement of the securing region, in particular the part of the securing region which has the securing contour, at the end can make production easier.

Various embodiments relate to configurations of the axial drill bit securing means. The axial drill bit securing means can enhance user comfort and improve the handling of the drilling device. A positive axial securing means enables secure fixing of the drill bit in the drill bit fitting, especially when compared with securing means which secure by friction and which may fail under certain circumstances due to grease, oil etc. in the work area. A positive engagement element designed as a snap ring offers a low-cost and functional solution for this. Arranging the groove or the engagement groove on the side of the shank facing the drill bit tip allows simple mounting of the positive engagement element on the shank or in the receiving region.

A configuration in accordance with various embodiments provides a drill bit stop and a receiving stop, which simplify the mounting of the drill bit in the drill bit fitting and may thus improve the handling of the drilling device. For instance, the drill bit can be inserted into the drill bit fitting until the stops make contact, without the need for further alignment in the axial direction. Arranging the drill bit stop at the end, on the end face of the drill bit, in particular of the shank, which faces the drill bit fitting offers a possibility for configuration which is simple to implement in terms of design. Moreover, it is possible in this context, in the case where the drill bit is configured as a suction drill bit, that the contact between the stops can at least minimize deposition of extracted drilling dust in the receiving region. Furthermore, particularly in the case of connection to a hammer or impact power drill, it is possible for the impact force to be introduced directly and centrally into the drill bit via the stops.

Various embodiments relate to configurations concerning the receiving region, which allow improved force and torque transmission from the drill bit fitting to the drill bit during a drilling process, which is, in particular, relatively easy to produce. A receiving region which is configured in a manner that is similar in the mathematical sense to the securing region furthermore allows, for instance, the accurately fitting reception of the drill bit in the drill bit fitting. Making contact at at least three straight lines of contact furthermore allows, for instance, more uniform force and torque transmission.

Various embodiments relate to configurations of the drilling device with a sleeve. A mountable sleeve which has a corresponding mounting recess can improve the handling of the drilling device since, for instance, the sleeve can be mounted or removed easily when required. A positive axial securing means allows secure fixing of the sleeve. The sleeve designed as a spacing sleeve or as a drilling sleeve can extend the functionality of the drilling device. In the case of the sleeve designed as a drilling sleeve, a sleeve securing contour can enable improved force and torque transmission. The configurations of the sleeve securing contour in accordance with some embodiments are associated, for instance, with the advantages mentioned herein.

In various embodiments, the mounting region of the drill bit fitting is developed in an advantageous way, wherein the configurations allow improved force and torque transmission from the drill bit fitting to the sleeve during a drilling process.

The configurations in accordance with some embodiments can simplify the mounting of the sleeve on the drill bit fitting and accordingly improve the handling of the drilling device.

According to various embodiments, a drill bit, in particular a rock drill bit, it is provided. The drill bit has a shank for arrangement on a receiving region of a drill bit fitting of a drilling device, wherein the shank has a securing region for securing the fitted drill bit against rotation relative to the drill bit fitting, wherein the securing region has a securing contour along its length, wherein the securing contour has a plurality of curved shank arc segments and a plurality of shank connecting segments, which connect the shank arc segments to one another at a plurality of shank connection points.

It is significant here that the shank arc segments and the shank connecting segments merge tangentially into one another at the shank connection points.

In particular, the drill bit can be used for a drilling device according to the proposal. Reference may therefore be made to all the statements relating to the drilling device according to the proposal, in particular regarding the drill bit of the drilling device according to the proposal.

According to various embodiments, a drill bit fitting, in particular a drill bit fitting of a drilling device according to the proposal, is proposed. The drill bit fitting has a connection region for connection, in particular releasable connection, to a power drill, and a receiving region for receiving a drill bit, in particular by plug fitting.

A point here is that the drill bit fitting is designed in such a way that a drill bit according to the proposal can be received in or on the receiving region.

Reference may be made to all the statements relating to the drilling device according to the proposal and the drill bit according to the proposal.

According to various embodiments, a sleeve, in particular a spacing or drilling sleeve, is provided. The sleeve has a mounting recess for mounting on a mounting region of a drill bit fitting of a drilling device, wherein the mounting recess has a sleeve securing contour over at least part of its length to secure the fitted sleeve against rotation relative to the drill bit fitting, wherein the sleeve securing contour has a plurality of curved sleeve arc segments and a plurality of sleeve connecting segments, which connect the sleeve arc segments to one another at a plurality of sleeve connection points.

It is significant here that the sleeve arc segments and the sleeve connecting segments merge tangentially into one another at the sleeve connection points.

In particular, the sleeve can be used for a drilling device according to the proposal. Reference may be made to all the statements relating to the drilling device according to the proposal, the drill bit and the drill bit fitting.

According to various embodiments, a method for producing a drill bit according to the proposal is proposed, in which the securing region of the shank, which has the securing contour, is produced using a turning tool or, in particular, using a milling cutter, such as an end mill, and the turning tool or the milling cutter removes material in a direction transverse to the main axis of the shank. A method of this kind can, in particular, open up a possibility of producing the securing region of the shank in one work step, in particular without further finish machining.

Reference may be made to all the statements relating to the drilling device according to the proposal, the drill bit fitting, the sleeve and especially the drill bit according to the proposal.

According to various embodiments, a method for producing a drill bit fitting according to the proposal is provided, in which the part of the receiving region of the drill bit fitting which has the receiving contour is produced using a milling cutter, in particular an end mill, and the milling cutter removes material in a direction transverse to the main axis of the receiving region.

Reference may be made to all the statements relating to the drilling device according to the proposal, the drill bit, the sleeve and especially the drill bit fitting according to the proposal, and to the proposed method for producing a drill bit.

According to various embodiments, a method for producing a sleeve according to the proposal is provided. In this method, the part of the mounting recess of the sleeve which has the sleeve securing contour is produced using a milling cutter, in particular an end mill, wherein the milling cutter removes material in a direction transverse to the main axis of the mounting recess.

Reference may be made to all the statements relating to the drilling device according to the proposal, the drill bit, the drill bit fitting, especially the sleeve, the method for producing a drill bit and the method for producing a drill bit fitting.

Various embodiments provide a drilling device, in particular a suction drilling device, for drilling a drill hole, wherein the drilling device has a drill bit fitting and a drill bit, wherein the drill bit fitting has a connection region for connection of the drilling device to a power drill, and a receiving region for receiving the drill bit, wherein the drill bit has a shank, which is received by the receiving region, in particular inserted into the receiving region, in the fitted state and is fixed releasably in the axial direction by means of an axial drill bit securing means, wherein the shank has a securing region, wherein the securing region secures the drill bit against rotation relative to the drill bit fitting in the fitted state, wherein the securing region has a securing contour along its length, wherein the securing contour has a plurality of curved shank arc segments and a plurality of shank connecting segments, which connect the shank arc segments to one another at a plurality of shank connection points, wherein the shank arc segments and the shank connecting segments merge tangentially into one another at the shank connection points.

In various embodiments, the securing contour is of rotationally symmetrical configuration, in particular with at least threefold rotational symmetry, and/or wherein the securing contour has an equal number of shank arc segments and shank connecting segments, in particular in each case at least three, and/or wherein the shank arc segments are of substantially identical design, and/or wherein the shank connecting segments are of substantially identical design.

In various embodiments, the shank connecting segments are of uncurved design and, in particular, are each arranged on a side of an imaginary, in particular isosceles, polygon, and/or wherein the shank arc segments each form part of an ellipse or of a circle and each have one center which is different, in particular, from the other centers of the shank arc segments, and/or wherein the shank arc segments each form part of a hyperbola or of a parabola and each have one focus which is different, in particular, from the other focuses of the shank arc segments.

In various embodiments, the securing region extends over only part of the length of the shank, in particular at the end, and wherein the shank has one or more further shank regions, each having a shank contour, such as wherein, in the fitted state, the securing region faces the drill bit fitting, and the one or more further shank regions face away from the drill bit fitting.

In various embodiments, the axial drill bit securing means has a, in particular latching, first positive engagement element, which is arranged, in particular, on the receiving region or on the shank, such as wherein the axial drill bit securing means has a, in particular encircling, first groove, which is arranged, in particular, on the receiving region or on the shank, and wherein the axial drill bit securing means has a, in particular encircling, first engagement groove, which is arranged, in particular, on the shank or on the receiving region, and wherein the first positive engagement element, which is designed, in particular, as a snap ring, is arranged in the first groove and, in the fitted state, engages in the first engagement groove, as a further possibility wherein the first groove arranged on the shank or the engagement groove arranged on the shank is arranged in a central shank region of the shank, and the securing region is arranged at the end.

In various embodiments, the shank has a drill bit stop, and the receiving region has a receiving stop of corresponding configuration, which rest against one another at least temporarily during fitting and/or rest against one another in the fitted state, with the result that the position of the shank in the receiving region is fixed in the axial direction. In various embodiments, the drill bit stop is arranged at the end on an end face of the drill bit which faces the drill bit fitting, and wherein the receiving stop is arranged on a side of the receiving region which faces away from the insertion opening.

In various embodiments, the receiving region has a receiving contour at least over part of its length, and wherein the receiving region, in particular the receiving contour, is similar in the mathematical sense to the securing region, in particular the securing contour, and/or wherein the receiving region, in particular the receiving contour, is designed to correspond to the securing region, in particular the securing contour, of the shank in such a way that the securing region is in contact with the part of the receiving region which has the receiving contour at at least three straight lines of contact during drilling with the drilling device.

In various embodiments, the drilling device has a sleeve, such as wherein the drilling device, in particular the drill bit fitting, has a mounting region, and wherein the sleeve has a mounting recess, and wherein, in the fitted state, the sleeve is mounted on the mounting region by means of the mounting recess and is fixed releasably in the axial direction by means of an axial sleeve securing means. In various embodiments, the axial sleeve securing means has a, in particular latching, second positive engagement element, which is arranged on the mounting region or, in particular, on the mounting recess. In various embodiments, the axial sleeve securing means has a, in particular encircling, second groove, which is arranged on the mounting region or, in particular, on the mounting recess, and wherein the axial sleeve securing means has a, in particular encircling, second engagement groove, which is arranged, in particular, on the mounting region or on the mounting recess, and wherein the second positive engagement element, which is designed, in particular, as a snap ring, is arranged in the second groove and, in the fitted state, engages in the second engagement groove.

In various embodiments, the sleeve is designed as a spacing sleeve for defining a particular drilling depth, or wherein the sleeve is designed as a drilling sleeve for drilling into a construction material. In various embodiments, the mounting recess has a sleeve securing contour at least over part of its length, which, in the fitted state, secures the sleeve against rotation relative to the drill bit fitting, for which purpose the sleeve securing contour has a plurality of curved sleeve arc segments and a plurality of sleeve connecting segments, which connect the sleeve arc segments to one another at a plurality of sleeve connection points, and wherein the sleeve arc segments and the sleeve connecting segments merge into one another tangentially at the sleeve connection points.

In various embodiments, the sleeve securing contour is of rotationally symmetrical configuration, in particular with at least threefold rotational symmetry, and/or wherein the sleeve securing contour has an equal number of sleeve arc segments and sleeve connecting segments, in particular in each case at least three, and/or wherein the sleeve arc segments are of substantially identical design, and/or wherein the sleeve connecting segments are of substantially identical design.

In various embodiments, the sleeve connecting segments are of uncurved design and, in particular, are each arranged on a side of an imaginary isosceles polygon, and/or wherein the sleeve arc segments each form part of an ellipse or of a circle and each have one center which is different, in particular, from the other centers of the sleeve arc segments, and/or wherein the sleeve arc segments each form part of a hyperbola or of a parabola and each have one focus which is different, in particular, from the other focuses of the sleeve arc segments.

In various embodiments, the mounting region has a mounting contour at least over part of its length, and wherein the mounting region, in particular the mounting contour, is similar in the mathematical sense to the mounting recess, in particular the sleeve securing contour, and/or wherein the mounting region, in particular the mounting contour, is designed to correspond to the mounting recess, in particular the sleeve securing contour, in such a way that the part of the mounting recess which has the sleeve securing contour is in contact with the part of the mounting region which has the mounting contour at at least three straight lines of contact during drilling with the drilling device.

In various embodiments, the sleeve, in particular the mounting recess, has a sleeve stop, and the mounting region has a mounting stop of corresponding configuration, which, in the fitted state and/or during fitting, rest against one another at least temporarily, with the result that the position of the sleeve on the mounting region is fixed in the axial direction, such as wherein the sleeve stop is arranged within the sleeve, in particular in the mounting recess, and wherein the mounting stop is arranged at the end on an end face of the drill bit fitting which faces the drill bit.

Various embodiments provide a drill bit, in particular rock drill bit, wherein the drill bit has a shank for arrangement on a receiving region of a drill bit fitting of a drilling device, in particular a drilling device as described herein, wherein the shank has a securing region for securing the fitted drill bit against rotation relative to the drill bit fitting, wherein the securing region has a securing contour along its length, wherein the securing contour has a plurality of curved shank arc segments and a plurality of shank connecting segments, which connect the shank arc segments to one another at a plurality of shank connection points, wherein the shank arc segments and the shank connecting segments merge tangentially into one another at the shank connection points.

Various embodiments provide a drill bit fitting, in particular of a drilling device as described herein, wherein the drill bit fitting has a connection region for connection to a power drill, and a receiving region for receiving the drill bit, in particular by plug fitting, wherein the drill bit fitting is designed in such a way that a drill bit as described herein can be received in or on the receiving region.

Various embodiments provide a sleeve, in particular a spacing or drilling sleeve, wherein the sleeve has a mounting recess for mounting on a mounting region of a drill bit fitting of a drilling device, in particular of a drilling device as described herein, wherein the mounting recess has a sleeve securing contour over at least part of its length to secure the fitted sleeve against rotation relative to the drill bit fitting, wherein the sleeve securing contour has a plurality of curved sleeve arc segments and a plurality of sleeve connecting segments, which connect the sleeve arc segments to one another at a plurality of sleeve connection points, wherein the sleeve arc segments and the sleeve connecting segments merge tangentially into one another at the sleeve connection points.

Various embodiments provide a method for producing a drill bit as described herein, wherein the securing region of the shank, which has the securing contour, is produced using a turning tool or, in particular, using a milling cutter, such as an end mill, wherein the turning tool or the milling cutter removes material in a direction transverse to the main axis of the shank.

Various embodiments provide a method for producing a drill bit fitting as described herein, wherein the part of the receiving region of the drill bit fitting which has the receiving contour is produced using a milling cutter, in particular an end mill, wherein the milling cutter removes material in a direction transverse to the main axis of the receiving region.

Various embodiments provide a method for producing a sleeve as described herein, wherein the part of the mounting recess of the sleeve which has the sleeve securing contour is produced using a milling cutter, in particular an end mill, wherein the milling cutter removes material in a direction transverse to the main axis of the mounting recess.

### BRIEF DESCRIPTION OF THE DRAWING

Various aspects are explained in greater detail below with reference to a drawing, which illustrates only exemplary embodiments. In the drawing:

FIG. 1 shows a schematic illustration of a drilling device according to the proposal in a perspective view with a detail view and sectional views,

FIG. 2 shows a schematic illustration of a drill bit fitting according to the proposal and of a drill bit according to the proposal in two embodiments in perspective views with a detail view, and

FIG. 3 shows respective schematic illustrations of a drill bit fitting according to the proposal, in a) with a drilling sleeve and in b) with a spacing sleeve.

### DETAILED DESCRIPTION

The exemplary embodiment illustrated in the figures relates to a drilling device 1 for drilling a drill hole. Here, the drilling device 1 is designed as a suction drilling device, by means of which the construction material to be drilled, in particular stone, concrete, reinforced concrete or the like can be extracted as drilling dust during a drilling process.

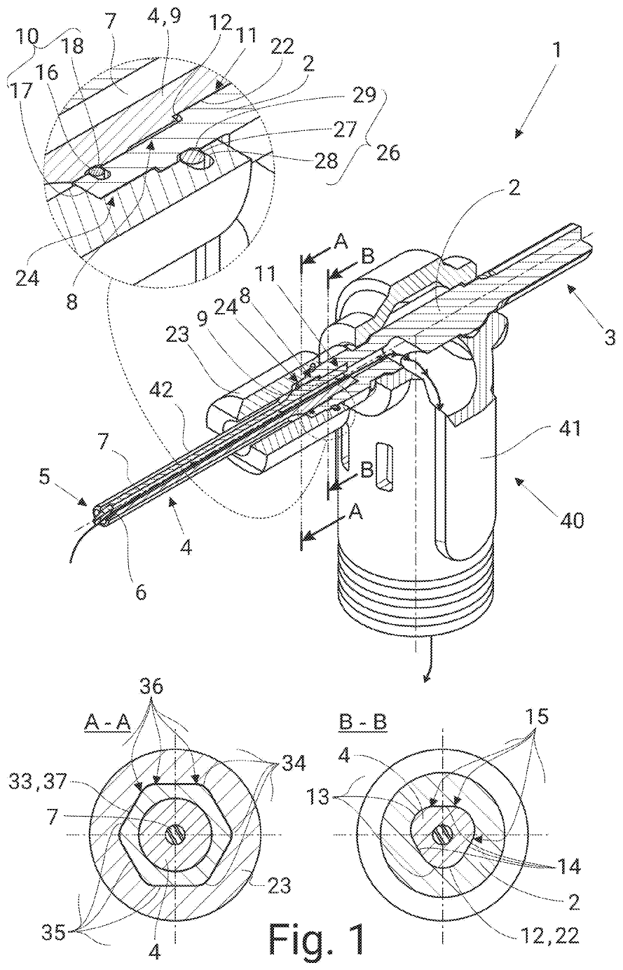

First of all, the drilling device 1 has a drill bit fitting 2, which is, in particular, of one-piece design. The drill bit fitting 2 has a connection region 3 for the releasable connection of the drilling device 1 to a power drill. A “power drill” should be understood to mean any kind of power drill, especially hammer, impact and/or rotary power drills. As illustrated in FIG. 1, the connection region 3 is an end-located connection region 3, which, for instance, can be clamped into a drill chuck of the power drill in a known manner. The connection region 3 can be designed, for instance, as a hexagonal or octagonal connection region 3. The connection region 3 can likewise be designed, for example, as an SDS-, in particular SDS-Plus- or SDS-Max-compatible connection region 3.

In addition to the drill bit fitting 2, the drilling device 1 has a drill bit 4. In various embodiments, the drill bit 4 is a rock drill bit, which, in particular, has a drill bit tip 5 with a cutting insert 6 at the end. In various embodiments, the drill bit 4 has a suction channel 7, via which the construction material to be drilled is extracted toward the drill bit fitting 2 as drilling dust during the drilling process.

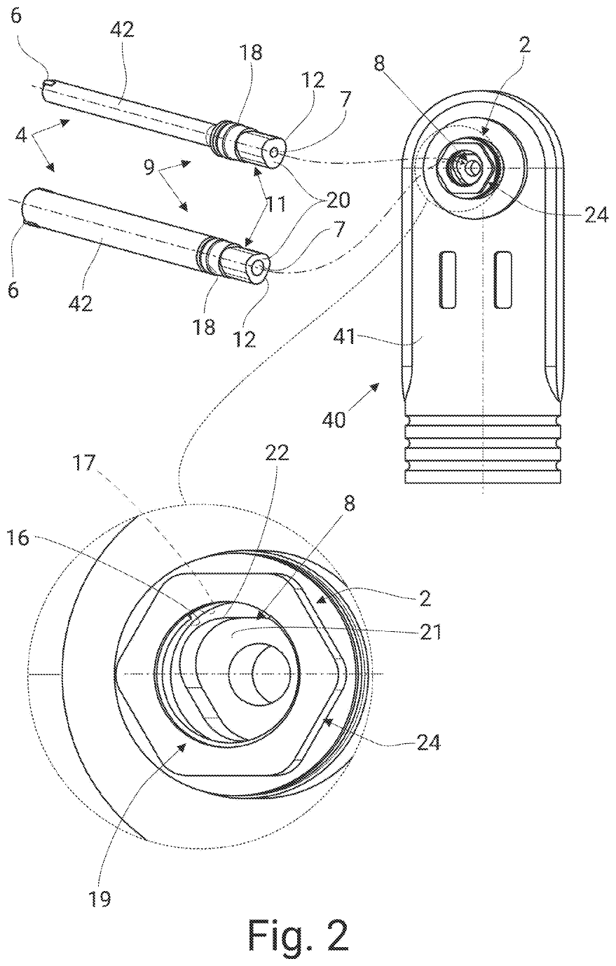

To receive the drill bit 4, the drill bit fitting 2 has a receiving region 8. As illustrated in FIGS. 1 and 2, the receiving region 8 can be a receiving region 8 located at the end and opposite the connection region 3. In various embodiments, the receiving region 8 is formed in the interior of the drill bit fitting 2, thus enabling the drill bit 4 to be correspondingly inserted into the receiving region 8. In principle, however, it is also conceivable for the receiving region 8 to be formed on the exterior of the drill bit fitting 2 and for the drill bit 4 to be correspondingly mountable on the receiving region 8.

The drill bit 4 of the drilling device 1 according to the proposal has a shank 9, which is received by the receiving region 8 in the fitted state, in particular being inserted (FIG. 1). In addition to the shank 9, the drill bit 4 can have a drilling shaft 42. The shank 9 can extend from one end of the drill bit 4 to the drilling shaft 42 in the direction of the drill bit tip 5. In various embodiments, the shank 9 of the drill bit 4 is that region of the drill bit 4 which is received at least partially, in particular completely, by the receiving region 8 in the fitted state. By means of an axial drill bit securing means 10 of the drilling device 1, the drill bit 4, in particular the shank 9, is fixed releasably in the axial direction in the drill bit fitting 2, in particular the receiving region 8. The axial drill bit securing means 10 can be configured at least in such a way here that the drill bit 4 can be removed from the drill bit fitting 2 by a user only by means of a manually applied force. In various embodiments, the drill bit 4 can be fixed automatically in the drill bit fitting 2 by the axial drill bit securing means 10 in the course of the insertion movement of the drill bit 4 into the drill bit fitting 2.

The axial direction refers to the direction of extent of the axis of rotation of the drill bit 4.

The shank 9 has a securing region 11, which secures the drill bit 4 against rotation relative to the drill bit fitting 2 in the fitted state. In various embodiments, the securing region 11 is designed as an end-located securing region 11 which, in particular, is arranged on the side of the shank 9 which faces away from the drill bit tip 5.

Along its length, in particular along its entire length, the securing region 11 has a securing contour 12, in particular a circumferentially encircling securing contour. The length of the securing region 11 extends in the axial direction of the drill bit 4. The securing contour 12 can be ascertained, for instance, from FIG. 1 (section B-B) and FIG. 2. The securing contour 12 is, in particular, the circumferential contour of the shank 9, such as of the securing region 11. In various embodiments, the securing contour 12 can be of constant design over the length of the securing region 11. Alternatively, however, it is conceivable for the securing contour 12 to vary at least in some region or regions over the length of the securing region 11, for instance due to recesses, conical configuration etc. in some region or regions. “Circumferentially” or “circumference” refers to a direction around the axis of rotation of the drill bit 4, such as in a plane orthogonal to the axis of rotation of the drill bit 4.

The configuration of the securing contour 12 is evident especially from the sectional illustration in FIG. 1. It is envisaged that the securing contour 12 has a plurality of curved shank arc segments 13 and a plurality of shank connecting segments 14, which connect the shank arc segments 13 to one another at a plurality of shank connection points 15. In particular, it is envisaged that each of the shank arc segments 13 is connected by in each case two shank connecting segments 14 to at least one, such as two, shank arc segments 13. In various embodiments, the securing contour 12 is designed as an encircling and/or outer securing contour 12.

The shank arc segments 13 have a curvature. In this case, the curvature can be constant over the length of the respective shank arc segment 13. In particular, the curvature of the individual shank arc segments 13 can be equal in magnitude to the curvature of the other shank arc segments 13. The curvatures of the shank arc segments 13 can be formed in the same direction in relation to the respective shank arc segment 13.

In various embodiments, the shank connecting segments 14 are of uncurved design and thus have no curvature. However, it is likewise conceivable that the shank connecting segments 14 have a curvature which, in particular, deviates from the curvature of the shank arc segments 13. In particular, it is possible for the curvature of the shank connecting segments 14 to be opposite to the curvature of the shank arc segments 13. The curvatures of the shank connecting segments 14 can be formed in the same direction in relation to the respective shank connecting segment 14.

The shank arc segments 13 each merge into two different shank connecting segments 14 at two shank connection points 15. In connection with the shank connection points 15, it can be possible that the, in particular all the, shank connection points 15 of the securing contour 12 are spaced apart by at least 0.7 mm, at least 1.4 mm, or at least 2.1 mm. In particular, in each case two shank connection points 15 which adjoin one of the shank arc segments 13 can be spaced apart by at least 0.7 mm, at least 1.4 mm, or at least 2.1 mm. For the case where the shank arc segments 13 are formed as part of a circle, this would correspond to a radius of curvature of the shank arc segments 13 of approximately at least 0.5 mm, approximately at least 1 mm, or approximately at least 1.5 mm.

Now, it can be essential in some embodiments that the, in particular all the, shank arc segments 13 and the, in particular all the, shank connecting segments 14 merge tangentially into one another at the, in particular all the, shank connection points 15. Thus, a tangential transition is formed at the shank connection points 15. This results in a securing contour 12 which is of corner-less design. The securing region 11 is correspondingly of edge-less design along its length.

It can be provided that the securing contour 12 is of rotationally symmetrical configuration. This can result in a rotationally symmetrical securing region 11, at least in the part of the securing region 11 which has the securing contour 12. The rotational symmetry is obtained in relation to the main axis of the drill bit 4. As is apparent in FIGS. 1 and 2, the securing contour 12 is configured with at least threefold rotational symmetry. It can be that the securing contour 12 is configured with at most twelve-fold rotational symmetry.

In addition to the securing contour 12 and the securing region 11, it is conceivable, in particular, that the shank 9 is of rotationally symmetrical design. The drill bit 4 with a rotationally symmetrical shank 9 can be capable of being received, in particular inserted, into the receiving region 8 of the drill bit fitting 2 in several angular positions, for instance. This is the case for instance with the drill bits illustrated by way of example in FIG. 2.

Alternatively or in addition, provision can be made for the securing contour 12 to have an equal number of shank arc segments 13 and shank connecting segments 14. As is evident for instance from FIG. 1, in each case two shank arc segments 13 can be connected to one another by one shank connecting segment 14. Alternatively or in addition, it is possible for in each case two shank connecting segments 14 to be connected to one another by one shank arc segment 13. In this context, provision can be made for the securing contour 12 to have at least three shank arc segments 13 and at least three shank connecting segments 14.

The shank arc segments 13, in particular all the shank arc segments 13, can be of substantially identical design. The shank arc segments 13 can be of substantially identical design especially in respect of their curvature, their length and/or their orientation with respect to one another, as can be seen, for example, from FIG. 1. Alternatively or in addition, the shank connecting segments 14, in particular all the shank connecting segments 14, can be of substantially identical design. The shank connecting segments 14 can be of substantially identical design especially in respect of their curvature, their length and/or their orientation with respect to one another, as can be seen by way of example from FIG. 1.

As depicted in FIGS. 1 and 2 and in various embodiments, the securing contour 12 comprises precisely three shank arc segments 13 and precisely three shank connecting segments 14. In this case, the shank arc segments 13 are of substantially identical design in respect of their curvature, their length and/or their orientation with respect to one another. The shank connecting segments 14 are likewise of substantially identical design in respect of their curvature, their length and/or their orientation with respect to one another. In various embodiments, the shank arc segments 13 each extend over an angular range of 120°. In various embodiments, the shank connecting segments 14 are of uncurved design, i.e. are designed as straight lines. In various embodiments, this results in an encircling securing contour 12 which is designed as a corner-less triangle, in particular a rotationally symmetrical corner-less triangle.

The, in particular all the, shank connecting segments 14 can be of uncurved design. Thus, the shank connecting segments 14 do not have any curvature and are each designed as straight segments. As a possibility, the shank connecting segments 14 are each arranged on a side of an imaginary, in particular isosceles, polygon. In FIG. 1 for instance and in various embodiments, the shank connecting segments 14 are each arranged on a side of an imaginary isosceles triangle.

In various embodiments, the, in particular all the, shank arc segments 13 each form part of a circle. The shank arc segments 13 can thus have, in particular, a constant curvature over the respective shank arc segment 13. In this case, the shank arc segments 13 each have one center which is different, in particular, from the other centers of the shank arc segments 13. Alternatively, it is likewise conceivable for each of the shank arc segments 13 to form part of an ellipse and/or for each of the shank arc segments 13 to form part of a hyperbola or of a parabola, wherein the shank arc segments 13 each have one focus which is different, in particular, from the other focuses of the shank arc segments 13.

Furthermore, it can be seen by way of example from FIG. 2 and it can be provided that the securing region 11 extends over only part of the length of the shank 9, in particular at the end. The shank 9 therefore also has one or more further shank regions, which each have a shank contour that deviates from the securing contour 12. The shank regions can be arranged one behind the other in the axial direction of the drill bit 4. As depicted in FIGS. 1 and 2 and in various embodiments, the securing contour 11 extends over only part, at least 20%, at least 35%, or at least 40%, of the length of the shank 9. In this case, the securing region 11 is arranged at the end, that is to say at one end, namely the end facing the drill bit fitting 2, of the drill bit 4 and, in particular, of the shank 9. As is evident from FIG. 2, for instance, the shank 9 also has further shank regions, each with different shank contours.

The shank contours are, in particular, the circumferential contour of the shank 9 in the respective shank region. In various embodiments, it is envisaged that the securing region 11, which has the securing contour 12, is the longest in comparison with the other shank regions of the shank 9, which, in particular, adjoins the drilling shaft 42.

As can be seen, for example, from FIG. 1 and in various embodiments, the securing region 11 faces the drill bit fitting 2 and the one or more further shank regions face away from the drill bit fitting 2 in the fitted state. This results in the arrangement of the securing region 11 at the end of the drill bit 4.

For releasable fixing of the drill bit 4 in the drill bit fitting 2, provision can be made for the axial drill bit securing means 10 to have a first positive engagement element 16. In particular, the first positive engagement element 16 can be a latching first positive engagement element 16, making it possible, in particular, for the drill bit 4 to be inserted and latched into the drill bit fitting 2.

According to FIG. 2 and in various embodiments, the positive engagement element 16 is arranged on, in particular in, the receiving region 8. Provision can be made for the axial drill bit securing means 10 to have an encircling first groove 17 which, in various embodiments, is arranged on, in particular in, the receiving region 8. Provision can furthermore be made for the axial drill bit securing means 10 to have an encircling first engagement groove 18 which, in various embodiments, is arranged on the shank 9. The positive engagement element, which is designed, in particular, as a snap ring, is arranged in the first groove 17 (FIG. 2) and, in the fitted state of the drill bit 4, engages in the first engagement groove 18 (FIG. 1).

As an alternative to this embodiment, it is likewise conceivable for the positive engagement element 16 to be arranged on the shank 9. In this context, provision can be made for the axial drill bit securing means 10 to have an encircling first groove 17 which is arranged on the shank 9. The axial drill bit securing means 10 can furthermore have an encircling first engagement groove 18, which is arranged on, in particular in, the receiving region 8. Here too, the positive engagement element 16, which is designed, in particular, as a snap ring, can be arranged in the first groove 17 and, in the fitted state of the drill bit 4, can engage in the first engagement groove 18.

In both alternatives, provision can be made for the first groove 17 arranged on the shank 9 or the engagement groove arranged on the shank 9 to be arranged in a central shank region of the shank 9 and for the securing region 11 to be arranged at the end. As a result, as can be seen from FIG. 2 for instance, the central shank region faces the drill bit tip 5 of the drill bit 4, in particular with respect to the securing region 11, and the securing region 11 faces away from the drill bit tip 5 of the drill bit 4, in particular with respect to the central shank region.

As illustrated, for example, in FIGS. 1 and 2 and in various embodiments, the first groove 17 is spaced apart from an insertion opening 19 of the receiving region 8, through which the shank 9 can be inserted into the receiving region 8, by at most 15 mm, at most 7 mm, or at most 2 mm.

In various embodiments, it is furthermore envisaged that the shank 9 has a drill bit stop 20, and the receiving region 8 has a correspondingly configured receiving stop 21. During fitting, that is to say, for instance, while the drill bit 4 is being inserted into the drill bit fitting 2, the drill bit stop 20 and the receiving stop 21 rest against one another at least temporarily. It is conceivable that the drill bit stop 20 and the receiving stop 21 rest against one another in the fitted state, especially when the axial drill bit securing means 10 fixes the drill bit 4 in position in the drill bit fitting 2. Through the temporary contact or contact existing in the fitted state, the position of the shank 9 in the receiving region 8 can be fixed in the axial direction. As a possibility, the drill bit stop 20 is arranged at the end on an end face of the drill bit 4 which faces the drill bit fitting 2, and the receiving stop 21 is arranged on a side of the receiving region 8 which faces away from the insertion opening 19, as is evident by way of example from FIG. 1, in which the drill bit stop 20 is formed by the end face, and the receiving stop 21 is formed by the base of the receiving region 8.

Provision can be made for the receiving region 8 to have a receiving contour 22 at least over part of its length, and for the receiving region 8, in particular the receiving contour 22, to be similar in the mathematical sense to the securing region 11, in particular the securing contour 12. In various embodiments, the receiving contour 22 is designed as an inner and/or encircling receiving contour 22. The receiving contour 22 is, in particular, the, in some embodiments inner, circumferential contour of at least part of the receiving region 8. “Similar in the mathematical sense” means that one region or one contour can be mapped onto another region or another contour by scaling, in particular only by scaling, that is to say, for instance, by being stretched in all directions. Thus, in this case, the receiving region 8 or the receiving contour 22 can be mapped onto the securing region 11 or the securing contour 12 by being stretched, in the specific case by being reduced in size. This presupposes, in particular, that the length ratios of corresponding sides of the region or of the contour and the angle ratios of corresponding angles of the region or of the contour are the same. Here, the receiving region 8 has, over a certain length, a receiving contour 22 which is somewhat larger than the securing contour 12 but substantially the same in respect of its length ratios and angle ratios. It is thereby possible to achieve a corresponding fit which enables the drill bit 4 to be accommodated in the receiving region 8.

Alternatively or in addition, it can be possible for the clearance between the part of the receiving region 8 which has the receiving contour 22 and the part of the securing region 11 which has the securing contour 12 to be at most 0.2 mm, at most 0.1 mm, or at most 0.05 mm, at least over a certain length, at least 50%, or at least 80%, of the part of the securing region 11 which has the securing contour 12.

Alternatively or in addition, it is possible for the receiving region 8, in particular the receiving contour 22, to be designed to correspond to the securing region 11 of the shank 9, in particular the securing contour 12, in such a way that the securing region 11 is in contact with the part of the receiving region 8 which has the receiving contour 22 at at least three straight lines of contact during drilling with the drilling device 1. Via the straight lines of contact, the force is transmissible from the drill bit fitting 2 to the drill bit 4 during the drilling process. This configuration can be achieved, for instance, if the clearance between the part of the receiving region 8 which has the receiving contour 22 and the part of the securing region 11 which has the securing contour 12 is provided in accordance with the above description. In particular, the clearance enables the drill bit 4 to be rotated relative to the drill bit fitting 2 during the drilling process by a small angular range, in particular an angular range of at most 2°, at most 1°, or at most 0.8°, with the result that the corresponding parts of the regions make contact at the at least three straight lines of contact. It is possible that the straight lines of contact run substantially parallel to the main axis of the shank 9 and/or that the straight lines of contact are spaced apart at equal angles from one another. It is furthermore possible that the straight lines of contact have a certain transverse extent.

For better fitting of the shank 9 with the securing contour 12, the receiving contour 22 is designed as a kind of counterpart to the securing contour 12. Reference can therefore be made in a very general way to all the embodiments and features which are described in connection with the securing contour 12.

In various embodiments, provision is furthermore made for the drilling device 1 to have a sleeve 23. For fastening the sleeve 23, the drilling device 1, in particular the drill bit fitting 2, can have a mounting region 24 and the sleeve 23 has a mounting recess 25. By means of the mounting recess 25, the sleeve 23 can be mounted on and removed from the mounting region 24 as required. In particular, the mounting recess 25 is formed in the interior of the sleeve 23. In particular, the mounting region 24 is formed on an outer surface of the drill bit fitting 2. As can be seen, for instance, from FIG. 1, the mounting region 24 can at least partially surround the receiving region 8, in particular in the radial direction of the drill bit fitting 2.

In FIG. 1, the sleeve 23 is mounted on, for instance. In order to prevent the sleeve 23 from slipping off the mounting region 24, the sleeve 23 can be fixed releasably in the axial direction by means of an axial sleeve securing means 26. It has proven particularly expedient for the axial sleeve securing means 26 to be of identical or at least similar design to the axial drill bit securing means 10. Reference can therefore be made in a very general way to all the embodiments and features which are described in connection with the axial drill bit securing means 10.

In particular in the context of the axial sleeve securing means 26, it can be that the axial sleeve securing means 26 has a, in particular latching, second positive engagement element 27, which is arranged on the mounting recess 25, as is the case for instance in FIGS. 1 and 2. In various embodiments, the axial sleeve securing means 26 has an encircling second groove 28, and an encircling second engagement groove 29, wherein the second groove 28 is arranged on, in particular in, the mounting recess 25 of the sleeve 23, and the second engagement groove 29 is arranged on the mounting region 24 of the drill bit fitting 2. The second positive engagement element 27, which, in various embodiments, is designed as a snap ring, is arranged in the second groove 28 (FIG. 2) and, in the fitted state, engages in the second engagement groove 29 (FIG. 1).

As an alternative to this, as also already explained in connection with the axial drill bit securing means 10, it is likewise conceivable that the encircling second groove 28 is arranged on the mounting region 24 of the drill bit fitting 2, and the encircling second engagement groove 29 is arranged on, in particular in, the mounting recess 25 of the sleeve 23. In this case, the second positive engagement element 27 is correspondingly arranged in the second groove 28 on the drill bit fitting 2 and, in the fitted state, engages in the second engagement groove 29 of the sleeve 23.

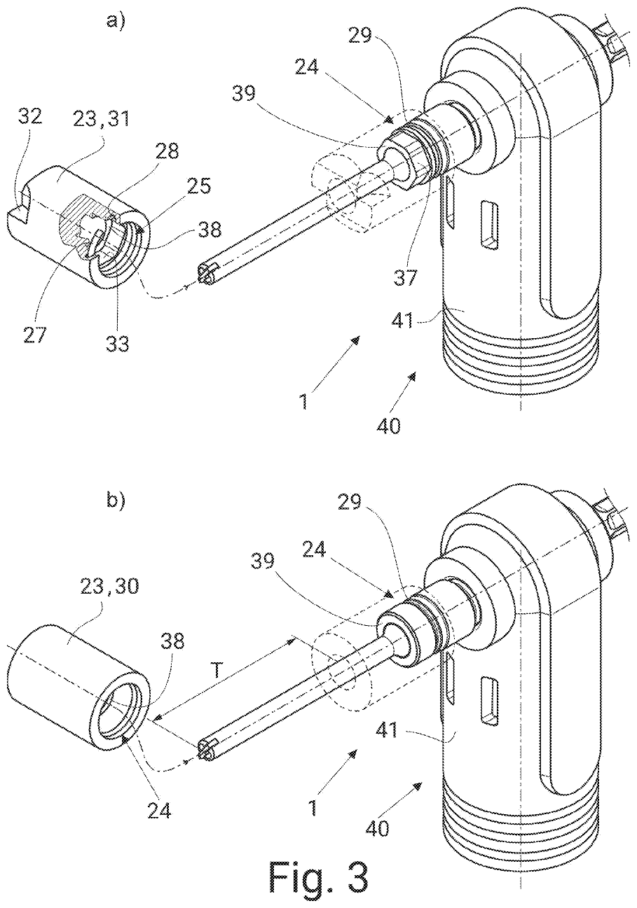

The sleeve 23 can be assigned various tasks and functions, and therefore it should be configured according to the application. In various embodiments, for instance, that the sleeve 23 is designed as a spacing sleeve 30 for defining a particular drilling depth T, as can be seen by way of example in FIG. 3b). In various embodiments, the drilling depth T results from the difference in length of the drill bit 4 received, in particular inserted, in the drill bit fitting 2 and the sleeve 23 arranged, in particular mounted, on the drill bit fitting 2. During a drilling process, drilling is continued until the end face of the sleeve 23 strikes against a construction material, such as a wall. It is possible for the drilling depth T to be defined as required by appropriate choice of a sleeve 23 designed as a spacing sleeve. In various embodiments, the sleeve 23 is of rotationally symmetrical design.

Alternatively, it is likewise conceivable for the sleeve 23 to be designed as a drilling sleeve 31 for drilling into a construction material, as is the case, for instance, with the sleeve 23 illustrated in FIGS. 1 and 3a). In this context, “drilling sleeve” 31 also includes sleeves 23 which tend to cut rather than drill a construction material, e.g. a wallboard, wood, or the like. In various embodiments, the sleeve 23 has at least one, in some embodiments two opposite, drilling surfaces 32 which are arranged on a side, in particular end face, of the sleeve 23 which faces away from the drill bit fitting 2. In various embodiments, the drill bit 4 serves as a centering drill for the sleeve 23. In order to secure the sleeve 23 designed as a drilling sleeve 31 against rotation relative to the drill bit fitting 2 in the fitted state, in particular during the drilling process, the mounting recess 25 has a sleeve securing contour 33 at least over part of its length (FIG. 3a). In various embodiments, the sleeve securing contour 33 is designed as an inner and/or encircling sleeve securing contour 33. The sleeve securing contour 33 is, in particular, the, in some embodiments inner, circumferential contour of at least part of the mounting recess 25. The sleeve securing contour 33 has a plurality of curved sleeve arc segments 34 and a plurality of sleeve connecting segments 35, which connect the sleeve arc segments 34 to one another at a plurality of sleeve connection points 36. The sleeve arc segments 34 and the sleeve connecting segments 35 merge tangentially into one another at the sleeve connection points 36. This is illustrated, for example, in FIG. 1.

It has proven particularly expedient for the sleeve securing contour 33, while being differently dimensioned, to be designed in the manner of the securing contour 12. Reference can therefore be made in a very general way to all the embodiments and features which are described in connection with the securing contour 12.

In particular, the sleeve securing contour 33 can be of constant design over the length of the part of the mounting recess 25 which has the sleeve securing contour 33, or it can vary, e.g. by means of recesses in some region or regions, etc.

A configuration of the sleeve securing contour 33 is evident especially from the sectional illustration in FIG. 1 (A-A). It is envisaged that the sleeve securing contour 33 has a plurality of curved sleeve arc segments 34 and a plurality of sleeve connecting segments 35, which connect the sleeve arc segments 34 to one another at a plurality of sleeve connection points 36. In particular, it is envisaged that each of the sleeve arc segments 34 is connected by in each case two sleeve connecting segments 35 to at least one, in various embodiments two, sleeve arc segments. In various embodiments, the sleeve securing contour 33 is designed as an encircling and/or inner sleeve securing contour 33.

The sleeve arc segments 34 have a curvature. In this case, the curvature can be constant over the length of the respective sleeve arc segment 34. In particular, the curvature of the individual sleeve arc segments 34 can be equal in magnitude to the curvature of the other sleeve arc segments 34. The curvatures of the sleeve arc segments 34 can be formed in the same direction in relation to the respective sleeve arc segment.

In various embodiments, the sleeve connecting segments 35 are of uncurved design and thus have no curvature. However, it is likewise conceivable that the sleeve connecting segments 35 have a curvature which, in particular, deviates from the curvature of the sleeve arc segments 34. In particular, it is possible for the curvature of the sleeve connecting segments 35 to be opposite to the curvature of the sleeve arc segments 34. The curvatures of the sleeve connecting segments 35 can be formed in the same direction in relation to the respective sleeve connecting segment.

The sleeve arc segments 34 each merge into two different sleeve connecting segments 35 at two different sleeve connection points 36. In connection with the sleeve connection points 36, it can be possible that the, in particular all the, sleeve connection points 36 of the sleeve securing contour 33 are spaced apart by at least 0.7 mm, at least 1.4 mm, or at least 2.1 mm. In particular, in each case two sleeve connection points 36 which adjoin one of the sleeve arc segments 34 can be spaced apart by at least 0.7 mm, at least 1.4 mm, or at least 2.1 mm. In some embodiments, where the sleeve arc segments 34 are formed as part of a circle, this would correspond to a radius of curvature of the sleeve arc segments 34 of approximately at least 0.5 mm, at least 1 mm, or at least 1.5 mm.

In particular, it can be provided that the sleeve securing contour 33 is of rotationally symmetrical configuration. This can result in a rotationally symmetrical mounting recess 25, at least in the part of the mounting recess 25 which has the sleeve securing contour 33. As is apparent in FIGS. 1 and 2 and in various embodiments, the sleeve securing contour 33 is configured with at least fourfold, in some embodiments sixfold, rotational symmetry. It can be that the securing contour 12 is configured with at most twelve-fold rotational symmetry.

As can be seen from FIGS. 1 and 2 and in various embodiments, the sleeve securing contour 33 has an equal number, in particular at least four, sleeve arc segments 34 and sleeve connecting segments 35. Alternatively or in addition, the, in particular all the, sleeve arc segments 34, can be of substantially identical design and/or the, in particular all the, sleeve connecting segments 35 can be of substantially identical design.

In FIGS. 1, 2 and 3a) and in various embodiments, the sleeve securing contour 33 comprises precisely six sleeve arc segments 34 and precisely six sleeve connecting segments 35. In this case, the sleeve arc segments 34 are of substantially identical design in respect of their curvature, their length and/or their orientation with respect to one another. The sleeve connecting segments 35 are likewise of substantially identical design in respect of their curvature, their length and/or their orientation with respect to one another. In various embodiments, the sleeve arc segments 34 each extend over an angular range of 60°. In various embodiments, the sleeve connecting segments 35 are of uncurved design, i.e. are designed as straight lines. In various embodiments, this results in an encircling sleeve securing contour 33, which is designed as a corner-less hexagon, in particular a rotationally symmetrical corner-less hexagon.

In various embodiments, it is furthermore envisaged that the, in particular all the, sleeve connecting segments 35 are of uncurved design, i.e. are each designed as straight segments. In various embodiments, the, in particular all the, sleeve connecting segments 35 can each be arranged on a side of an imaginary, in particular isosceles, polygon. As included in various embodiments, FIG. 1 depicts that the sleeve connecting segments 35 are each arranged on a side of an imaginary isosceles hexagon.

Alternatively or in addition, the sleeve arc segments 34 each form part of an ellipse or of a circle and each have one center which is different, in particular, from the other centers of the sleeve arc segments 34. As included in various embodiments, FIG. 1 depicts that the sleeve arc segments 34 each form part of a circle with a constant curvature. Alternatively or in addition, the sleeve arc segments 34 each form part of a hyperbola or of a parabola and each have one focus which is different, in particular, from the other focuses of the sleeve arc segments 34.

To enable the sleeve 23 to be correspondingly mounted on the drill bit fitting 2, the mounting region 24, in some embodiments, has a mounting contour 37 at least over part of its length. In various embodiments, the mounting contour 37 is designed as an outer and/or encircling mounting contour 37. The mounting contour 37 is, in particular, the, in some embodiments outer, circumferential contour of at least part of the mounting region 24. The mounting region 24, in particular the mounting contour 37, can be similar in the mathematical sense to the mounting recess 25, in particular the sleeve securing contour 33. It can be seen by way of example from FIG. 3a) that the mounting region 24 of the drill bit fitting 2 has, over a certain length, a mounting contour 37 which is somewhat smaller than the sleeve securing contour 33 but substantially the same in respect of its length ratios and angle ratios.

Alternatively or in addition, it can be possible for the clearance between the part of the mounting region 24 which has the mounting contour 37 and the part of the mounting recess 25 which has the sleeve securing contour 33 to be at most 0.2 mm, at most 0.1 mm, or at most 0.05 mm, at least over a certain length, at least 50%, or at least 80%, of the part of the mounting recess 25 which has the sleeve securing contour 33.

Alternatively or in addition, it is possible for the mounting region 24, in particular the mounting contour 37, to be designed to correspond to the mounting recess 25, in particular the sleeve securing contour 33, in such a way that the part of the mounting recess 25 which has the sleeve securing contour 33 is in contact with the part of the mounting region 24 which has the mounting contour 37 at at least three straight lines of contact, in various embodiments six straight lines of contact, during drilling with the drilling device 1. Via the straight lines of contact, the force is transmissible from the drill bit fitting 2 to the sleeve 23 designed as a drilling sleeve 31 during the drilling process. This configuration can be achieved, for instance, by providing the clearance between the mounting region 24 and the mounting recess 25 in accordance with the above description. In particular, the clearance enables the sleeve 23 to be rotated relative to the drill bit fitting 2 during the drilling process by a small angular range, in particular an angular range of at most 2°, at most 1°, or at most 0.8°, with the result that the corresponding parts of the regions make contact at the at least three straight lines of contact, in various embodiments six straight lines of contact. It is possible that the straight lines of contact run substantially parallel to the main axis of the sleeve 23 and/or that the straight lines of contact are spaced apart at equal angles from one another. It is furthermore possible that the straight lines of contact have a certain transverse extent.

Although the mounting region 24 is designed in accordance with the configuration of the sleeve 23 in FIGS. 3a) and 3b), it is fundamentally possible for the mounting region 24 of a drilling device 1 to be designed in such a way that either a spacing sleeve or a drilling sleeve 31 can be mounted on the drill bit fitting 2. This is the case, for instance, with the mounting region 24 in FIGS. 1, 2 and 3a). In various embodiments, the mounting region 24 and the respective mounting recess 25 of the spacing sleeve or the drilling sleeve 31 are designed in such a way that, in the fitted state, the spacing sleeve 30 is not secured against rotation and the drilling sleeve 31 is secured against rotation.

For better fitting of the sleeve 23 with the sleeve securing contour 33, the mounting contour 37 is designed as a kind of counterpart to the sleeve securing contour 33. Reference can therefore be made in a very general way to all the embodiments and features which are described in connection with the sleeve securing contour 33.

It can be envisaged that the sleeve 23, in particular the mounting recess 25, has a sleeve stop 38 and the mounting region 24 has a mounting stop 39 of corresponding configuration, which, in the fitted state and/or during fitting, rest against one another at least temporarily. It is thereby possible to fix the position of the sleeve 23 on the mounting region 24 in the axial direction. FIGS. 3a) and 3b) show the sleeve stop 38 and the mounting stop 39, for instance. In various embodiments, the sleeve stop 38 is arranged within the sleeve 23, in particular in the mounting recess 25, and the mounting stop 39 is arranged at the end on an end face of the drill bit fitting 2 which faces the drill bit 4. In various embodiments, the sleeve stop 38 is formed by the base of the mounting recess 25, and the mounting stop 39 is formed by the end face of the mounting region 24.

As can be seen from FIGS. 1, 2, 3a) and 3b) and in various embodiments, the drilling device 1 furthermore has an extraction arrangement 40. The extraction arrangement 40 can have an extraction housing 41. The drill bit fitting 2 can be rotatably mounted in the extraction housing 41 (FIG. 1). The extraction housing 41 can have a connection for a suction device.

In addition to the drilling device 1, a drill bit 4, in particular a rock drill bit, is furthermore proposed. The drill bit 4 has a shank 9 for arrangement on a receiving region 8 of a drill bit fitting 2 of a drilling device 1, in particular a drilling device 1 according to the proposal, wherein the shank 9 has a securing region 11 for securing the fitted drill bit 4 against rotation relative to the drill bit fitting 2, wherein the securing region 11 has a securing contour 12 along its length, wherein the securing contour 12 has a plurality of curved shank arc segments 13 and a plurality of shank connecting segments 14, which connect the shank arc segments 13 to one another at a plurality of shank connection points 15.

In this context it is significant that the shank arc segments 13 and the shank connecting segments 14 merge tangentially into one another at the shank connection points 15.

The drill bit 4 according to the proposal can be for a drilling device 1 according to the proposal, and therefore reference may be made to all the statements relating to the drilling device 1, in particular suction drilling device, according to the proposal.

It is conceivable that, as can be seen by way of example in FIGS. 1, 2, 3a) and 3b), the drill bit 4 has a drilling shaft 42 with a cutting insert 6 at the end. The drilling shaft 42 is arranged adjacent to the shank 9 of the drill bit 4, in particular on the side of the drill bit 4 which faces away from the drill bit fitting 2. The drilling shaft 42 is designed in such a way that it centers the drill bit 4 during the drilling process and/or carries away construction material.

It is furthermore possible for the drill bit 4 to have an internal suction channel 7. The suction channel 7 extends through the drilling shaft 42 as far as and at least partially through the shank 9 (FIG. 1). The suction channel 7 can be designed as a cylindrical opening. The suction channel 7 can be of straight design. The suction channel 7 can be matched to the drill bit size (FIG. 2). The shank 9 can be designed independently of the drill bit size, in particular can be the same for different drill bit sizes.

Furthermore, a drill bit fitting 2, in particular of a drilling device 1 according to the proposal, is also proposed. The drill bit fitting 2 has a connection region 3 for connection to a power drill, and a receiving region 8 for receiving the drill bit 4, in particular by plug fitting.

The essential point for the drill bit fitting 2 is that the drill bit fitting 2 is designed in such a way that a drill bit 4 according to the proposal can be received in or on the receiving region 8.

The drill bit fitting 2 according to the proposal can be for a drilling device 1 according to the proposal, and therefore reference may be made to all the statements relating to the drilling device 1, in particular suction drilling device, according to the proposal. Furthermore, the drill bit fitting 2 according to the proposal can receive a drill bit 4 according to the proposal, and therefore reference may be made to all the statements relating to the drill bit 4 according to the proposal.

A proposal is also made for a sleeve 23, in particular a spacing or drilling sleeve 31. The sleeve 23 has a mounting recess 25 for mounting on a mounting region 24 of a drill bit fitting 2 of a drilling device 1, in particular of a drilling device 1 according to the proposal, wherein the mounting recess 25 has a sleeve securing contour 33 over at least part of its length to secure the fitted sleeve 23 against rotation relative to the drill bit fitting 2, wherein the sleeve securing contour 33 has a plurality of curved sleeve arc segments 34 and a plurality of sleeve connecting segments 35, which connect the sleeve arc segments 34 to one another at a plurality of sleeve connection points 36.

In this context, it is significant that the sleeve arc segments 34 and the sleeve connecting segments 35 merge tangentially into one another at the sleeve connection points 36.

The sleeve 23 according to the proposal can be for a drilling device 1 according to the proposal. Reference may be made to all the statements relating to the drilling device 1, in particular suction drilling device, according to the proposal, the drill bit 4, in particular rock drill bit, and the drill bit fitting 2 according to the proposal.

Moreover, there is a proposal for a method for producing a drill bit 4 according to the proposal, wherein the securing region 11 of the shank 9, which has the securing contour 12, is produced using a turning tool or, in particular, using a milling cutter, such as an end mill, and the turning tool or the milling cutter removes material in a direction transverse to the main axis of the shank 9.

Reference may be made to all the statements relating to the drill bit 4 according to the proposal and also relating to the drilling device 1, in particular suction drilling device, according to the proposal, the drill bit fitting 2 and the sleeve 23.

In particular, it is possible that the securing region 11 of the shank 9, in particular the securing contour 12, is produced in a single work step, in particular without finish machining. No further finish machining is necessary here.

It is possible that the main axis of the milling cutter while the milling cutter is removing material is oriented substantially parallel to the main axis of the shank 9. It is also possible that the main axis of the turning tool while the turning tool is removing material is oriented substantially transversely, in particular orthogonally, to the main axis of the shank 9.

A proposal is also made for a method for producing a drill bit fitting 2 according to the proposal, wherein the part of the receiving region 8 of the drill bit fitting 2 which has the receiving contour 22 is produced using a milling cutter, in particular an end mill, and the milling cutter removes material in a direction transverse to the main axis of the receiving region 8.

Reference may be made to all the statements relating to the drill bit fitting 2 according to the proposal and also to the drilling device 1, the drill bit 4, the sleeve 23 and the method for producing a drill bit 4.

A proposal is also made for a method for producing a sleeve 23 according to the proposal, wherein the part of the mounting recess 25 of the sleeve 23 which has the sleeve securing contour 33 is produced using a milling cutter, in particular an end mill, wherein the milling cutter removes material in a direction transverse to the main axis of the mounting recess 25.

Reference may be made to all the statements relating to the drilling device 1 according to the proposal, the drill bit 4 according to the proposal, the drill bit fitting 2 according to the proposal, the sleeve 23 according to the proposal, and the methods according to the proposal.

1. A drilling device for drilling a drill hole,
wherein the drilling device has a drill bit fitting and a drill bit,
wherein the drill bit fitting has a connection region for connection of the drilling device to a power drill, and a receiving region for receiving the drill bit, wherein the drill bit has a shank, which is received by the receiving region, in the fitted state and is fixed releasably in the axial direction by an axial drill bit securing element,
wherein the shank has a securing region, wherein the securing region secures the drill bit against rotation relative to the drill bit fitting in the fitted state, wherein the securing region has a securing contour along its length, wherein the securing contour has a plurality of curved shank arc segments and a plurality of shank connecting segments, which connect the shank arc segments to one another at a plurality of shank connection points,
wherein the shank arc segments and the shank connecting segments merge tangentially into one another at the shank connection points.

2. The drilling device as claimed in claim 1, wherein the securing contour is of rotationally symmetrical configuration, and/or wherein the securing contour has an equal number of shank arc segments and shank connecting segments, and/or wherein the shank arc segments are of substantially identical design, and/or wherein the shank connecting segments are of substantially identical design.

3. The drilling device as claimed in claim 1, wherein the shank connecting segments are of uncurved design and are each arranged on a side of an imaginary polygon, and/or wherein the shank arc segments each form part of an ellipse or of a circle and each have one center which is different from the other centers of the shank arc segments, and/or wherein the shank arc segments each form part of a hyperbola or of a parabola and each have one focus which is different from the other focuses of the shank arc segments.

4. The drilling device as claimed in claim 1, wherein the securing region extends over only part of the length of the shank, and wherein the shank has one or more further shank regions, each having a shank contour.

5. The drilling device as claimed in claim 1, wherein the axial drill bit securing element has a first positive engagement element, which is arranged on the receiving region or on the shank.

6. The drilling device as claimed in claim 1, wherein the shank has a drill bit stop, and the receiving region has a receiving stop of corresponding configuration, which rest against one another at least temporarily during fitting and/or rest against one another in the fitted state, with the result that the position of the shank in the receiving region is fixed in the axial direction.

7. The drilling device as claimed in claim 1, wherein the receiving region has a receiving contour at least over part of its length, and wherein the receiving region is similar in the mathematical sense to the securing region and/or wherein the receiving region is designed to correspond to the securing region of the shank in such a way that the securing region is in contact with the part of the receiving region which has the receiving contour at at least three straight lines of contact during drilling with the drilling device.

8. The drilling device as claimed in claim 1, wherein the drilling device has a sleeve, wherein the drilling device has a mounting region, and wherein the sleeve has a mounting recess, and wherein, in the fitted state, the sleeve is mounted on the mounting region by the mounting recess and is fixed releasably in the axial direction by an axial sleeve securing element, as a further preference wherein the axial sleeve securing element has a second positive engagement element, which is arranged on the mounting region or on the mounting recess.

9. The drilling device as claimed in claim 8, wherein the sleeve is designed as a spacing sleeve for defining a particular drilling depth, or wherein the sleeve is designed as a drilling sleeve for drilling into a construction material, wherein the mounting recess has a sleeve securing contour at least over part of its length, which, in the fitted state, secures the sleeve against rotation relative to the drill bit fitting, for which purpose the sleeve securing contour has a plurality of curved sleeve arc segments and a plurality of sleeve connecting segments, which connect the sleeve arc segments to one another at a plurality of sleeve connection points, and wherein the sleeve arc segments and the sleeve connecting segments merge into one another tangentially at the sleeve connection points.

10. The drilling device as claimed in claim 9, wherein the sleeve securing contour is of rotationally symmetrical configuration and/or wherein the sleeve securing contour has an equal number of sleeve arc segments and sleeve connecting segments and/or wherein the sleeve arc segments are of substantially identical design, and/or wherein the sleeve connecting segments are of substantially identical design.

11. The drilling device as claimed in claim 9, wherein the sleeve connecting segments are of uncurved design and are each arranged on a side of an imaginary isosceles polygon, and/or wherein the sleeve arc segments each form part of an ellipse or of a circle and each have one center which is different from the other centers of the sleeve arc segments, and/or wherein the sleeve arc segments each form part of a hyperbola or of a parabola and each have one focus which is different from the other focuses of the sleeve arc segments.

12. The drilling device as claimed in claim 8, wherein the mounting region has a mounting contour at least over part of its length, and wherein the mounting region is similar in the mathematical sense to the mounting recess, and/or wherein the mounting region is designed to correspond to the mounting recess in such a way that the part of the mounting recess which has the sleeve securing contour is in contact with the part of the mounting region which has the mounting contour at at least three straight lines of contact during drilling with the drilling device.

13. The drilling device as claimed in claim 8, wherein the sleeve has a sleeve stop, and the mounting region has a mounting stop of corresponding configuration, which, in the fitted state and/or during fitting, rest against one another at least temporarily, with the result that the position of the sleeve on the mounting region is fixed in the axial direction, and wherein the mounting stop is arranged at the end on an end face of the drill bit fitting which faces the drill bit.

14. A drill bit, wherein the drill bit has a shank for arrangement on a receiving region of a drill bit fitting of a drilling device, wherein the shank has a securing region for securing the fitted drill bit against rotation relative to the drill bit fitting, wherein the securing region has a securing contour along its length, wherein the securing contour has a plurality of curved shank arc segments and a plurality of shank connecting segments, which connect the shank arc segments to one another at a plurality of shank connection points,
wherein the shank arc segments and the shank connecting segments merge tangentially into one another at the shank connection points.

15. A drill bit fitting, wherein the drill bit fitting has a connection region for connection to a power drill, and a receiving region for receiving the drill bit, in particular by plug fitting,
wherein the drill bit fitting is designed in such a way that a drill bit as claimed in claim 14 can be received in or on the receiving region.

16. A sleeve, wherein the sleeve has a mounting recess for mounting on a mounting region of a drill bit fitting of a drilling device, wherein the mounting recess has a sleeve securing contour over at least part of its length to secure the fitted sleeve against rotation relative to the drill bit fitting, wherein the sleeve securing contour has a plurality of curved sleeve arc segments and a plurality of sleeve connecting segments, which connect the sleeve arc segments to one another at a plurality of sleeve connection points,
wherein the sleeve arc segments and the sleeve connecting segments merge tangentially into one another at the sleeve connection points.

17. A method for producing a drill bit as claimed in claim 14, wherein the securing region of the shank, which has the securing contour, is produced using a turning tool or, in particular, using a milling cutter, wherein the turning tool or the milling cutter removes material in a direction transverse to the main axis of the shank.

18. A method for producing a drill bit fitting as claimed in claim 15, wherein the part of the receiving region of the drill bit fitting which has the receiving contour is produced using a milling cutter, in particular an end mill, wherein the milling cutter removes material in a direction transverse to the main axis of the receiving region.

19. A method for producing a sleeve as claimed in claim 16, wherein the part of the mounting recess of the sleeve which has the sleeve securing contour is produced using a milling cutter, wherein the milling cutter removes material in a direction transverse to the main axis of the mounting recess.

20. The drilling device as claimed in claim 4, wherein, in the fitted state, the securing region faces the drill bit fitting, and the one or more further shank regions face away from the drill bit fitting.
